(19) United States
(12) Patent Application Publication
(10) Pub. No.: US 2025/0280193 A1
(43) Pub. Date: Sep. 4, 2025

(54) ELECTRONIC DEVICE, SYSTEM, AND CONTROL METHOD

(71) Applicant: CANON KABUSHIKI KAISHA, Tokyo (JP)

(72) Inventor: HIROKAZU IZUOKA, Kanagawa (JP)

(21) Appl. No.: 19/059,953

(22) Filed: Feb. 21, 2025

(30) Foreign Application Priority Data
Mar. 4, 2024 (JP) 2024-031896

(51) Int. Cl. H04N 23/65; H02J 1/08

(52) U.S. Cl. CPC H04N 23/65; H02J 1/082

(57) ABSTRACT

An electronic device includes a communication unit configured to perform communication via a communication line. At startup, if the communication line's signal level is at a first level, the communication unit requests power at a first voltage from a predetermined power-supplying accessory. If the signal level is at a second level, the unit does not request power at the first voltage. A setting unit is provided to set the communication line's signal level to the second level after the accessory has been requested to supply power at the first voltage. Additionally, a control unit maintains the signal level of the communication line after the electronic device powers off, ensuring that the signal level remains consistent even when the device is turned off.

### BACKGROUND OF THE INVENTION

### Field of the Invention

The present invention relates to an electronic device, a system, and a control method.

### Description of the Related Art

Conventional power adapters that supply power to imaging devices have been known. These power adapters are designed in a shape that allows them to be mounted in the battery compartment of an imaging device, and by installing the power adapter in the battery compartment in place of a battery, power can be supplied to the imaging device from power sources including household power. Furthermore, by standardizing the shape of the battery compartment across different models, it has become possible to use batteries and power accessories interchangeably between different models.

With the advent of multi-functionality of imaging devices, the power

consumption by these imaging devices has been increasing. The increase in power consumption requires power accessories that can supply more power. Meanwhile, it is also effective to make it possible to use power accessories capable of supplying such high power for conventional imaging devices that have the same battery compartment shape but lower power consumption. Therefore, it is desirable that power accessories can supply power that is suitable for the imaging device to which they are attached. For example, it may be sufficient if the power accessory can output the appropriate voltage and current for the imaging device it is connected to.

The Universal Serial Bus Power Delivery (USB PD) standard that is compatible with the USB Type-C terminal has been known. Imaging devices and various other devices that are compatible with the USB PD standard have become widely available. According to the USB PD standard, power supply devices can supply multiple levels of voltage and current, and the power-receiving device can request a desired voltage level among the multiple levels that can be output by the power supply device. Therefore, it is effective for power accessories for imaging devices to have the function of a power-receiving device that supports the USB PD standard.

Japanese Patent Application Publication No. 2005-333709 discloses a DC adapter device having the “function of supplying driving power to an electronic device powered by dry cell batteries.” However, the document does not mention anything about supplying different levels of voltage depending on the electronic device.

By functioning as a power-receiving device compatible with the USB PD standard, the power accessory can receive different levels of voltage from the power supply device. Accordingly, the power accessory is connected to both the power supply device and the imaging device, and as the power accessory requests voltage corresponding to the imaging device from the power supply device, the voltage corresponding to the imaging device can be supplied from the power accessory to the imaging device. Meanwhile, according to the USB PD standard, when the power supply device and the power-receiving device are connected, power negotiation is performed, and after the power-receiving device requests the desired voltage to the power supply device, the power is supplied from the power supply device. When the imaging device is powered through a power accessory compatible with the USB PD standard, the imaging device must wait at startup until the requested voltage is output from the power supply device after the power accessory performs power negotiation with the USB PD-compatible power supply device.

In this way, a number of proceedings exist until the desired voltage is supplied to the imaging device from the power accessory. The imaging device desirably executes the startup processing after the necessary power is supplied to the imaging device from the power adapter. This can increase necessary startup time for the imaging device.

### SUMMARY OF THE INVENTION

It is therefore an object of the invention to prevent an increase in startup time for an electronic device capable of requesting voltage for power to be received from an accessory.

An aspect of the present invention is an electronic device to which a predetermined power-supplying accessory is detachably connected, the electronic device including: a processor; and a memory storing a program which, when executed by the processor, causes the electronic device to function as: a communication unit configured to perform communication with the predetermined accessory via a communication line, wherein the communication unit executes such communication processing that at startup of the electronic device, 1) the predetermined accessory is requested to supply power at a first voltage in case where the communication line has a signal level at a first level, and 2) the predetermined accessory is not requested to supply the power at the first voltage in case where the signal level of the communication line is a second level; a setting unit configured to perform setting processing to set the signal level of the communication line to the second level in case where the predetermined accessory is requested by the communication unit to supply the power at the first voltage; and a control unit configured to perform such control that after power off of the electronic device, the signal level of the communication line at the power-off of the electronic device is maintained.

An aspect of the present invention is a method for controlling an electronic device to which a predetermined power-supplying accessory is detachably connected, the method including: communicating with the predetermined accessory via a communication line, the communicating including, at startup of the electronic device, 1) requesting the predetermined accessory to supply power at a first voltage in case where the communication line has a signal level at a first level, and 2) refraining from requesting the predetermined accessory to supply the power at the first voltage in case where the signal level of the communication line is a second level; setting the signal level of the communication line to the second level in case where the predetermined accessory is requested to supply the power at the first voltage in the communicating; and controlling, after power-off of the electronic device, the signal level of the communication line at the power-off of the electronic device to be maintained.

Further features of the present invention will become apparent from the following description of exemplary embodiments with reference to the attached drawings.

### BRIEF DESCRIPTION OF THE DRAWINGS

FIG. 1 is an external view of a digital camera according to a first embodiment of the invention;

FIG. 2 is a diagram of the configuration of the digital camera according to the first embodiment;

FIG. 3 is a diagram of the configuration of an AC adapter according to the first embodiment;

FIG. 4 is a flowchart for illustrating processing conducted at the startup of the digital camera according to the first embodiment;

FIG. 5 is a flowchart for illustrating processing conducted at the shutdown of the digital camera according to the first embodiment; and

FIG. 6 is a flowchart for illustrating processing conducted by an AC adapter according to the first embodiment.

### DESCRIPTION OF THE EMBODIMENTS

Hereinafter, embodiments for carrying out the invention will be described in conjunction with the accompanying drawings.

### First Embodiment

In the description of a first embodiment of the invention, power negotiation is related to “digital cameras” and “AC adapters compatible with the USB PD standard.”

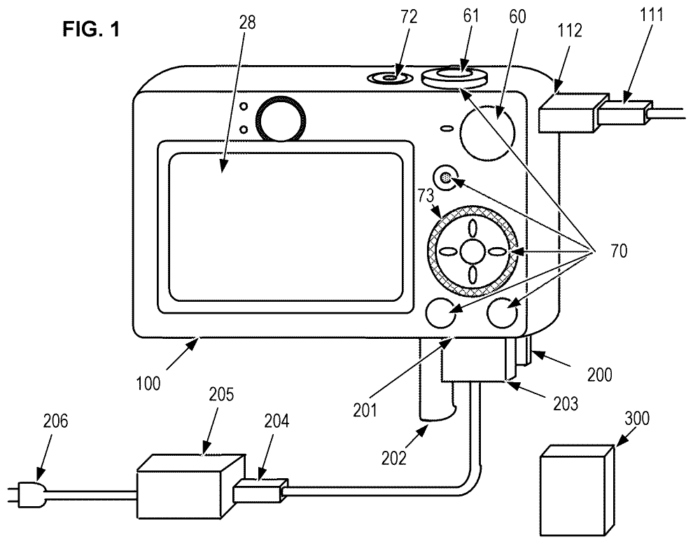

FIG. 1 is an external view of a digital camera 100 as an example of a device (electronic device) to which the embodiment is applicable. An AC adapter 203 is detachably connected to the digital camera 100. A display unit 28 displays images and various kinds of information. A shutter button 61 serves an operation unit that performs imaging instruction. A mode selection switch 60 serves as an operation unit to switch between modes. A connection cable 111 is used to connect with external devices (such as a personal computer and a printer). A connector 112 is a connector between the connection cable 111 and the digital camera 100. The operation unit 70 includes operation members (such as various switches, buttons, and a touch panel) that accept various kinds of operation from the user. A controller wheel 73 is a rotatable operation member included in the operation unit 70. A power switch 72 is a push button used to switch between power on and power off.

A recording medium 200 may be a memory card or a hard disk. The AC adapter 203 may be a predetermined power accessory that supplies the digital camera 100 with power. The AC adapter 203 includes a USB connector 204. The USB connector 204 is a USB Type-C connector. The USB connector 204 is connected with a PD power adapter 205 which is a power supply device compatible with the USB Power Delivery (USB PD) standard. The PD power adapter 205 is a power source device connected to a household power source via a plug 206. When the PD power adapter 205 is connected with a power-receiving device compatible with the USB PD standard via the USB Type-C cable, power is supplied from the PD power adapter 205 according to the USB PD standard. In FIG. 1, the AC adapter 203, which is a power-receiving device compatible with the USB PD standard, is connected to the PD power adapter 205, and power is supplied from the PD power adapter 205 to the AC adapter 203 according to the USB PD standard. In this way, power is stably supplied from the PD power adapter 205 to the digital camera 100 via the AC adapter 203.

A slot 201 is used to store the recording medium 200 and the AC adapter 203. The slot 201 has a battery compartment that is not shown, and when the battery 300 is used as the power source for the digital camera 100, a battery 300 is mounted in the battery compartment. When the AC adapter 203 is used as the power source for the digital camera 100, the AC adapter 203 is mounted in the battery compartment in place of the battery 300. The battery 300 and the AC adapter 203 have the same shape. The user can easily mount either the battery 300 or the AC adapter 203 in the battery compartment, and can also easily remove them from the battery compartment. The battery compartment is also provided with terminals for the digital camera 100 to communicate with the battery 300 or the AC adapter 203, and terminals for receiving power. When the terminals of the battery 300 or the AC adapter 203 are connected to these terminals, power can be supplied from the battery 300 or the AC adapter 203 and communication is enabled. The recording medium 200 stored in the slot 201 can communicate with the digital camera 100, such that images obtained from the digital camera 100 can be recorded and played back. The lid 202 is the lid for the slot 201. In FIG. 1, the lid 202 is open, and the recording medium 200 and the AC adapter 203 are partly taken out of the slot 201 and exposed. The USB cable can be pulled out to the outside when the 202 is closed.

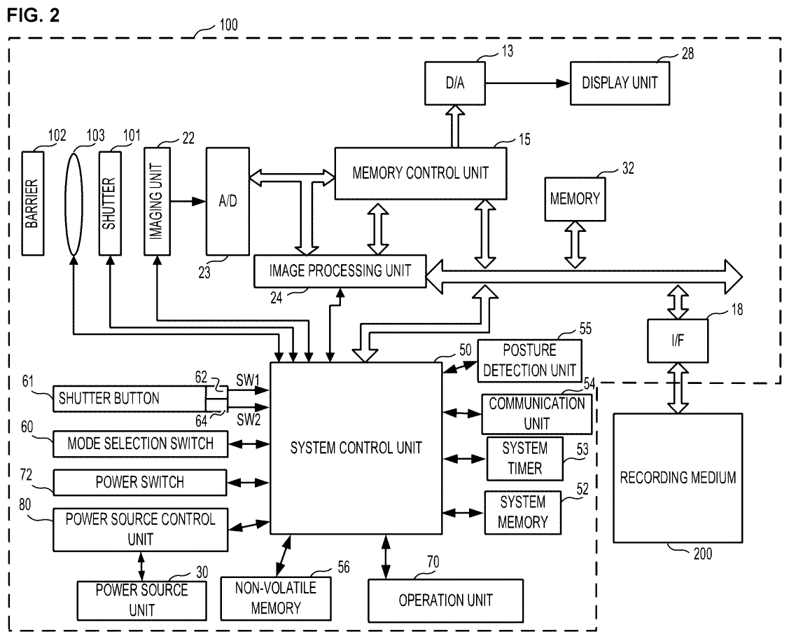

FIG. 2 is a block diagram of an exemplary configuration of the digital camera 100 according to the first embodiment. An imaging lens 103 is a group of lenses that includes a zoom lens and a focus lens. A shutter 101 includes an aperture function. An imaging unit 22 is an image sensing device (image sensor) including a CCD or CMOS element that converts an optical image into an electrical signal. An A/D converter 23 converts an analog signal into a digital signal. The A/D converter 23 is used to convert an analog signal output from the imaging unit 22 into a digital signal. The barrier 102 covers the imaging system (including the imaging lens 103, the shutter 101, and the imaging unit 22) to prevent the imaging system from becoming contaminated or damaged.

An image processing unit 24 performs image processing (predetermined pixel interpolation, resizing such as reduction, and color conversion processing) on data from the A/D converter 23 or data from a memory control unit 15. The image processing unit 24 also performs predetermined calculation processing using captured image data. A system control unit 50 performs exposure control and ranging control on the basis of the calculation results obtained by the image processing unit 24. In this way, TTL (Through-The-Lens) AF (Autofocus) processing, AE (Auto Exposure) processing, and EF (pre-flash emission) processing are performed. The image processing unit 24 also performs predetermined calculation processing using the captured image data. The image processing unit 24 performs TTL AWB (Auto White Balance) processing on the basis of the obtained calculation results.

The output data from the A/D converter 23 is written to a memory 32 via the image processing unit 24 and the memory control unit 15 or directly via the memory control unit 15. The memory 32 stores image data obtained by the imaging unit 22 and converted to digital data by the A/D converter 23. The memory 32 stores image data for display on the display unit 28. The memory 32 includes sufficient storage capacity to store a predetermined number of still images, a predetermined duration of moving images, and audio.

The memory 32 also serves as a memory (video memory) for displaying images. The D/A converter 13 converts data for image display stored in the memory 32 into an analog signal and supplies it to the display unit 28. In this way, the image data for display written to memory 32 is transmitted to the display unit 28 via the D/A converter 13. The display unit 28 performs a display according to the analog signal from the D/A converter 13 on a display device such as an LCD. The signal is first A/D converted by the A/D converter 23 and then stored to memory 32 as a digital signal. The digital signal is converted to an analog signal by the D/A converter 13, and the signal after the analog conversion is sequentially transferred to the display unit 28. The display unit 28 then functions as an electronic viewfinder, displaying a live image (live view (LV) display). Hereafter, the image displayed in live view will be referred to as an LV image.

The non-volatile memory 56 is a recording medium that can be electrically erased and recorded. For example, an EEPROM is used as the non-volatile memory 56. The non-volatile memory 56 may store constants and programs for operating the system control unit 50. The term “program” here refers to a computer program for executing the various flowcharts that will be described later in connection with the first embodiment.

The system control unit 50 includes at least one processor and/or at least one circuit. The system control unit 50 controls the entire digital camera 100. The system control unit 50 executes the programs recorded in the non-volatile memory 56 described above to realize the various kinds of processing according to the first embodiment which will be described. A RAM may be used for a system memory 52. The system memory 52 may store constants, variables, and programs read from the non-volatile memory 56 to be used for the operation of the system control unit 50. The system control unit 50 also controls for example the memory 32, the D/A converter 13, and the display unit 28 to perform display control.

A system timer 53 is a timing unit that measures the time used for various controls and the time of the built-in clock.

The mode selection switch 60, the shutter button 61, and the operation unit 70 are operation members that input various operation instructions to the system control unit 50. The mode selection switch 60 is used to switch the operation mode of the system control unit 50 to one of a still image recording mode, a moving image recording mode, and a playback mode. The still image recording mode includes an auto shooting mode, an auto scene determination mode, a manual mode, an aperture priority mode (Av mode), a shutter speed priority mode (Tv mode), and a program AE mode. The still image recording mode also includes various scene modes and custom modes, which correspond to shooting settings for different shooting scenes. Using the mode selection switch 60, the user can directly switch between these modes. Alternatively, after switching to the list screen of the shooting modes using the mode selection switch 60, the user can select any one of the multiple displayed modes and switch the modes using another operation member. Similarly, the moving image shooting mode may also include multiple modes.

When turned (ON) in the process of operating the shutter button 61 provided on the digital camera 100, specifically upon a so-called half-press (shooting preparation command), the first shutter switch 62 generates a first shutter switch signal SW1. The first shutter switch signal SW1 causes operation such as AF (Auto Focus), AE (Auto Exposure), AWB (Auto White Balance), and EF (Flash Pre-Emission) to start.

When turned (ON) upon the completion of the operation of the shutter button 61, specifically upon a so-called full press (shooting command), the second shutter switch 64 generates a second shutter switch signal SW2. The system control unit 50 starts a series of shooting processing operations (from reading out a signal from the imaging unit 22 to writing image data to the recording medium 200) in response to the generated second shutter switch signal SW2.

The operation members of the operation unit 70 serve as various function buttons. The operation members of the operation unit 70 are assigned functions as appropriate for various situations, for example by selecting various function icons displayed on the display unit 28. Examples of the function buttons include an end button, a back button, a forward button, a jump button, a narrowing button, and an attribute change button. For example, when the menu button is pressed, a menu screen with various settings that can be made is displayed on the display unit 28. The user can intuitively make various settings using the menu screen displayed on the display unit 28 and four direction buttons (up, down, left, and right) and a SET button.

The controller wheel 73 is a rotatable operation member included in the operation unit 70. The controller wheel 73 is used together with the direction buttons for example to indicate selection items. When the controller wheel 73 is rotated, an electrical pulse signal is generated according to the amount of rotation, and the system control unit 50 controls each part of the digital camera 100 in response to the pulse signal. The pulse signal can be used to determine the degree of rotation of the controller wheel 73 and the number of rotations. The controller wheel 73 can be any type of operation member that can detect rotational operation. For example, the controller wheel 73 can be a dial operation member that generates a pulse signal by rotation of the controller wheel 73 itself in response to rotating operation by the user. Alternatively, the operation member can be a touch sensor that detects the rotational movement of the user's finger on the controller wheel 73, without rotating the controller wheel 73 itself (so-called touch wheel).

A power source control unit 80 may include a battery detection circuit, a DC-DC converter, and a switch circuit (a circuit that switches the block to be energized).

The power source control unit 80 detects whether a battery is mounted, the type of battery, and the remaining battery capacity. The power source control unit 80 also controls the DC-DC converter in response to detection results and instructions from the system control unit 50 to supply necessary voltage to various elements including the recording medium 200 for a necessary period of time.

The power source unit 30 is the battery 300 or the AC adapter 203. The battery 300 may include a primary battery (such as an alkaline battery and a lithium battery) or a secondary battery (such as a NiCd battery, a NiMH battery, and a Li battery). In the description of the first embodiment, the AC adapter 203 is mounted in the slot 201 to constitute the power source unit 30. While the power source unit 30 may be included in the digital camera 100, the first embodiment will be described assuming that it is not included in the digital camera 100. Therefore, the description of the first embodiment relates to a system that includes the digital camera 100, the power source unit 30 (AC adapter 203), and the PD power adapter 205.

A recording medium I/F 18 serves as an interface with the recording medium 200 such as a memory card and a hard disk. The recording medium 200 may be a memory card for recording captured images. The recording medium 200 has for example a semiconductor memory, an optical disk, or a magnetic disk.

A communication unit 54 is connected either wirelessly or via a wired cable to transmit and receive video and audio signals. The communication unit 54 can also be connected to a wireless LAN (Local Area Network) or the Internet. The communication unit 54 can also communicate with external devices using Bluetooth (registered trademark) or Bluetooth Low Energy. The communication unit 54 can transmit images captured by the imaging unit 22 (including live images) and images recorded on the recording medium 200. The communication unit 54 can also receive image data and various other types of information from external devices.

A posture detection unit 55 detects the posture of the digital camera 100 in relation to the direction of gravity. It can be determined, on the basis of the posture detected by the posture detection unit 55, “whether an image taken with the imaging unit 22 is an image taken with the digital camera 100 held horizontally or vertically.” The system control unit 50 can add the posture information corresponding to the posture detected by the posture detection unit 55 to the image file of the image taken by the imaging unit 22, or can rotate the image for recording. The posture detection unit 55 may be an acceleration sensor or a gyro sensor. The posture detection unit 55 may also detect the movement of the digital camera 100 (such as pan, tilt, lift, and whether it is stationary) using an acceleration sensor or a gyro sensor.

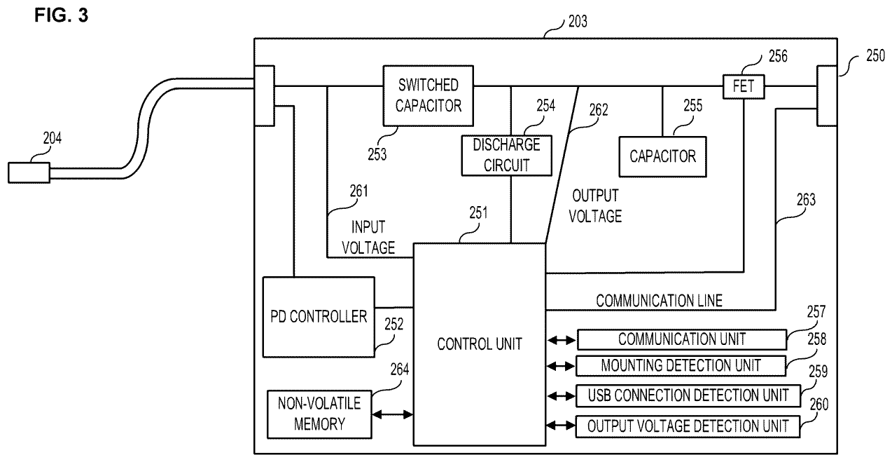

FIG. 3 is a block diagram of an exemplary configuration of the AC adapter 203 according to the first embodiment.

A terminal 250 is an electrical contact with the digital camera 100. The terminal 250 includes a power terminal and a communication terminal. Connecting the communication terminal and a communication line 263 with each other enables communication between the power source control unit 80 and a control unit 251 by the communication unit 257.

A PD controller 252 communicates with the PD power adapter 205 when the PD power adapter 205 is connected to the USB connector 204. The PD controller 252 is connected with the control unit 251. The register of the PD controller 252 can be changed by the control unit 251.

A switched capacitor 253 is a switched capacitor type DC-DC converter. The switched capacitor 253 converts input voltage to a fraction (one over an integer) and outputs (generates) output voltage. Here, the switched capacitor 253 converts the input voltage to half (½) for output.

A capacitor 255 is a high-capacitance capacitor that can secure power to be used for shutdown processing by the digital camera 100. The capacitor 255 is connected to the output of the switched capacitor 253 and therefore holds the output voltage (voltage output from the AC adapter 203 to the digital camera 100).

A discharge circuit 254 discharges the charge of the capacitor 255 under the control of the control unit 251. The FET 256 is a field-effect transistor. The FET 256 controls the output of the power of the AC adapter 203 under the control of the control unit 251.

An input voltage wiring 261 connects input voltage from the PD power adapter 205 connected via the USB connector 204 to the control unit 251. An output voltage wiring 262 connects the output of the switched capacitor 253 to the control unit 251.

The mounting detection unit 258 detects whether the AC adapter 203 is mounted in the slot 201 of the digital camera 100.

The USB connection detection unit 259 detects whether the USB connector 204 is connected to the PD power adapter 205. The output voltage detection unit 260 A/D converts the signal from the output voltage wiring 262 to detect the output voltage. A non-volatile memory 264 holds operation parameters.

When the USB connector 204 is connected to the PD power adapter 205, the PD power adapter 205 first supplies 5 V as the input voltage, and various parts of the AC adapter 203 are activated with power supplied from PD adapter 205. Next, the PD controller 252 conducts USB PD power negotiation with the PD power adapter 205 via the USB connector 204, and requests the PD power adapter 205 to supply power at 15V/3 A. When power at 15 V is supplied from the PD power adapter 205, the input voltage is converted to half of the voltage by the switched capacitor 253, and 7.5 V, which is half of 15 V, is output as voltage from terminal 250. In this way, in the initial state immediately after startup of the AC adapter 203, a voltage of 7.5 V (initial voltage) is output from the terminal 250. As will be described later, if no command requesting an output voltage of 10 V from the digital camera 100 is transmitted, the AC adapter 203 outputs an output voltage of 7.5 V. The control unit 251 can also control the PD controller 252 to conduct power negotiation to request a supply of power at 20 V/3 A. Also in this case, the input voltage is converted to half by the switched capacitor 253, and a voltage of 10 V is output to the terminal 250. The digital camera 100 according to the first embodiment is designed to be operable at a voltage of 10 V. It is also possible that another model of digital camera that can be connected to the AC adapter 203 may be designed to be operable at a voltage of 7.5 V. In the description of the first embodiment, when voltages of 10 V and 7.5 V can be output from the AC adapter 203, but the output voltages are not limited to these. For example, if the AC adapter 203 can be connected to multiple models of digital camera, the initial voltage can be the lowest voltage requested by these multiple models of digital camera in order to prevent the digital camera 100 from breaking down due to the supply of high-voltage power to the digital camera 100.

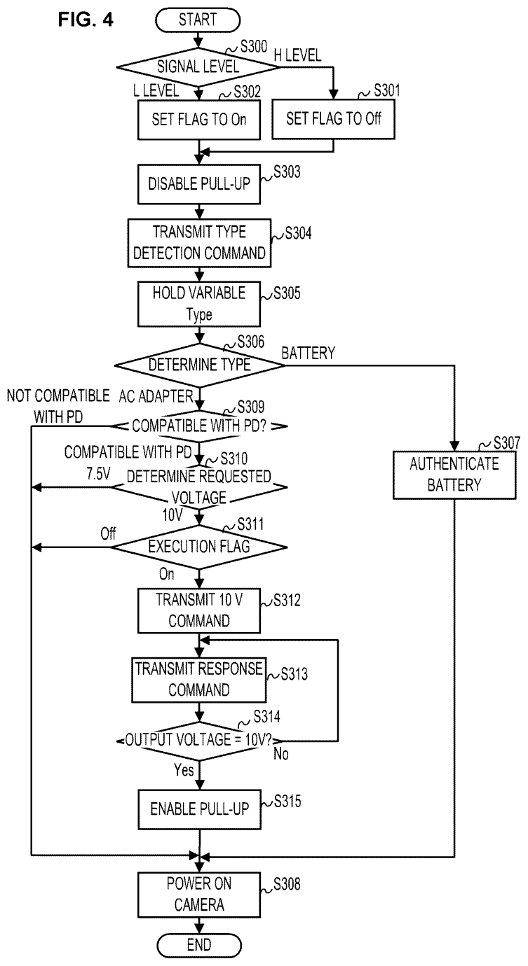

With reference to the flowchart of FIG. 4, among the kinds of processing performed by the system control unit 50, processing carried out upon the startup of the digital camera 100 (electronic device) will be described. The processing in FIG. 4 is performed as the CPU of the system control unit 50 executes a program stored in the non-volatile memory 56. Hereinafter, the communication between the digital camera 100 and the power source unit 30 is controlled by the communication unit 54 in the digital camera 100. The term “startup” here includes the processing started when the user operates the power switch 72 to turn on the power while the digital camera 100 is in the power-off state. The term also includes the processing started when the digital camera 100 resumes from the auto power-off state.

In step S300, the system control unit 50 reads the signal level of the communication line that connects the power source unit 30 and the power source control unit 80. If the communication line is set to I (p.u.), which enables the internal pull-up setting, there is no communication between the system control unit 50 and the control unit 251 in the AC adapter 203. Therefore, in this case, an H level is read as the signal level of the communication line. If it is determined that the signal level of the communication line is the H level, the process proceeds to step S301. If it is determined that the signal level of the communication line is an L level, the process proceeds to step S302.

In step S301, the system control unit 50 sets a negotiation execution flag (hereinafter referred to as an “execution flag”) which is a “flag indicating whether the power source unit 30 performs negotiation” to Off. Then, the system control unit 50 holds the execution flag set to Off (execution flag indicating that negotiation is not to be performed) in the RAM of the system memory 52.

In step S302, the system control unit 50 sets the execution flag to On and then stores the execution flag (execution flag indicating that negotiation is to be performed) in the RAM of the system memory 52.

In step S303, the system control unit 50 performs such control that communication between the power source control unit 80 and the power source unit 30 is enabled by disabling the pull-up operation of the communication line between the power source control unit 80 and the power source unit 30. Note that while the pull-up may be either an internal or external pull-up, an internal pull-up is used according to the first embodiment.

In step S304, the system control unit 50 controls the power source control unit 80 to transmit a command that requests information for the determination of the type (battery type) of the power source unit 30 (hereinafter referred to as a “type determination command”) to the power source unit 30 (the power source unit 30 mounted in the slot 201). The digital camera 100 can be connected to either the battery 300 or the AC adapter 203. Both the battery 300 and the AC adapter 203 are capable of communicating with the power source control unit 80. Therefore, the power source control unit 80 can determine the type of battery by communicating with the power source unit 30.

When the command is transmitted from the digital camera 100 in step S304, the system control unit 50 repeatedly switches the signal level of the communication line between the power source control unit 80 and the power source unit 30 between the L level and the H level. When the transmission of the command is completed, the system control unit 50 returns the present signal level to the signal level before the transmission of the command. Such processing is also performed in steps S312 and S313 which will be described later.

In step S305, the system control unit 50 obtains information on the battery type from the power source unit 30. The system control unit 50 holds the variable Type indicating the battery type in the RAM of the system memory 52.

In step S306, the system control unit 50 determines whether the power source unit 30 (the power source unit 30 mounted in the slot 201) is the AC adapter 203 (power supply accessory) or the battery 300, with reference to the variable Type. If it is determined that the power source unit 30 is the battery 300, the process proceeds to step S307. If it is determined that the power source unit 30 is the AC adapter 203, the process proceeds to step S309.

In step S307, the system control unit 50 attempts to authenticate the battery 300 and determines whether the battery 300 is an authenticated battery. If it is determined that the battery 300 is not an authenticated battery, control is performed for example “to display guidance on the display unit 28 notifying that the battery 300 is not an authenticated battery and to inquires of the user whether to use the battery.”

In step S308, the system control unit 50 executes the power-on processing of the digital camera 100. Specifically, the system control unit 50 controls the power source control unit 80 to supply power to each block of the digital camera 100. If the power source unit 30 is the battery 300, the power-on processing is executed using the power from the battery 300. This enables the system control unit 50 to operate functions such as taking or playing back images (still images or moving images). The startup processing of the digital camera 100 is completed when processing in step S308 is finished. Therefore, the time required from the start of the processing of the flowchart to the end of processing in step S308 is the startup time of the digital camera 100.

In step S309, the system control unit 50 determines whether the AC adapter 203 is compatible with the USB PD standard on the basis of the variable Type held in step S305. If it is determined that the AC adapter 203 is compatible with the USB PD standard, the process proceeds to step S310. If it is determined that the AC adapter 203 is not compatible with the USB PD standard, the process proceeds to step S308. When the AC adapter is not compatible with the USB PD standard, the output voltage cannot be changed, and for example, a predetermined voltage is supplied from the AC adapter. The predetermined voltage does not have to be 10 V and can be any voltage that allows the digital camera 100 to operate.

In step S310, the system control unit 50 determines the voltage requested by the digital camera 100 (hereinafter referred to as the “requested voltage”) in the process of executing the program for processing shown in FIG. 4 on the basis of the information read out from the non-volatile memory 56. The requested voltage by the digital camera 100 according to the first embodiment is 10 V. Therefore, it is determined here that the requested voltage is 10 V, and since it is necessary to request the AC adapter 203 to supply an output voltage of 10 V, the process proceeds to step S311. Depending on the model of the digital camera, the requested voltage may be 7.5 V. In this case, since the power at the initial voltage of 7.5 V is already supplied from the AC adapter 203, negotiation is not necessary, and the process proceeds to step S308.

In step S311, the system control unit 50 determines the setting of the execution flag held in steps S301 and S302. If it is determined that the execution flag is set to On (the signal level is the L level at startup), the process proceeds to step S312. If it is determined that the execution flag is set to Off (the signal level is the H level at startup), the process proceeds to step S308.

In step S312, the system control unit 50 requests the AC adapter 203 to supply an output voltage of 10 V by sending a command to the AC adapter 203 that instructs the AC adapter 203 to switch the output voltage from the AC adapter 203 to 10 V (hereinafter referred to as the “10 V command”). In this way, the system control unit 50 transmits the 10 V command if it is determined in step S311 that the execution flag is set to On (the signal level of the communication line at startup of the digital camera 100 is an L level). In this way, the system control unit 50 requests the AC adapter 203 to supply power at 10 V to the digital camera 100. Meanwhile, if it is determined in step S311 that the execution flag is set to Off (the signal level of the communication line at startup of the digital camera 100 is the H level), the system control unit 50 does not transmit the 10 V command. d. In other words, in such a case, the system control unit 50 does not request the AC adapter 203 to supply power at 10 V to the digital camera 100. Therefore, the digital camera 100 is supplied from the AC adapter 203 with the power at the voltage, which has been requested most recently (in the past) of the AC adapter 203 (the power at the voltage most recently supplied from the AC adapter 203 to the digital camera 100).

In step S313, the system control unit 50 transmits a response command to the AC adapter 203. The response command requests to respond with the output voltage of the power output from the AC adapter 203 to the digital camera 100. The system control unit 50 also obtains the output voltage information from the AC adapter 203.

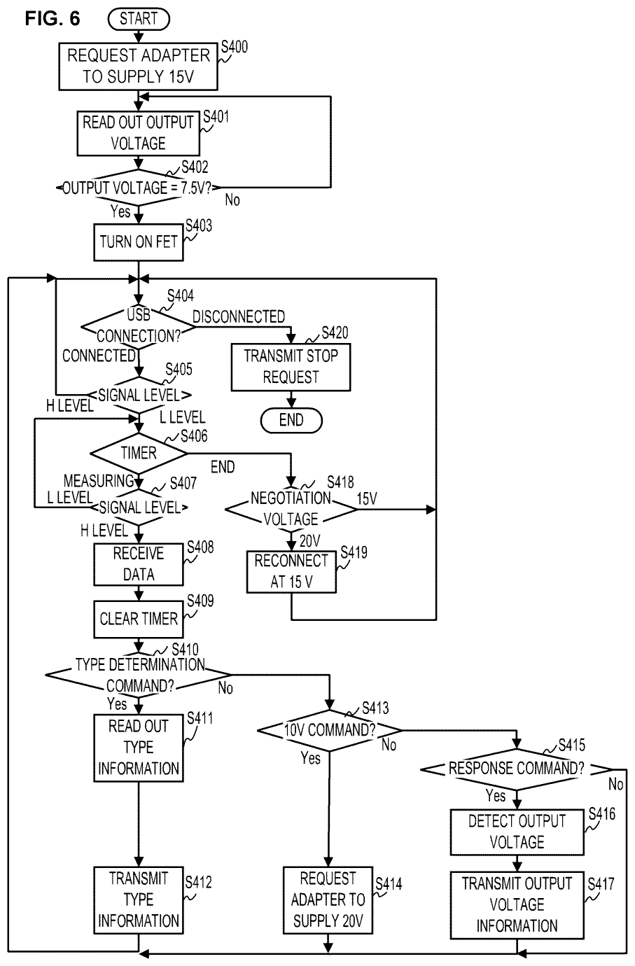

In response to the commands sent in steps S312 and S313, the control unit 251 of the AC adapter 203 performs the processing from step S410 onwards in the flowchart shown in FIG. 6, which will be described later.

In step S314, the system control unit 50 reads out the information on the output voltage from the AC adapter 203 obtained in step S313. The system control unit 50 then determines whether the output voltage is 10 V. If it is determined that the output voltage is 10 V, the process proceeds to step S315. If it is determined that the output voltage is not 10 V, the processing in steps S313 and S314 is repeated until it is determined in step S314 that the output voltage is 10 V.

In step S315, the system control unit 50 enables the internal pull-up of the communication line between the power source control unit 80 and the AC adapter 203. This sets the signal level of the communication line between the power source control unit 80 and the power source unit 30 to the H level. Thereafter, when it is necessary to communicate with the AC adapter 203, the system control unit 50 disables the internal pull-up in the same way as in step S303 and enables the internal pull-up again in the same way as in step S315 after the communication is complete.

If the AC adapter 203 is removed from the slot 201, power is no longer supplied to the digital camera 100, so that the communication line between the power source control unit 80 and the power source unit 30 cannot be maintained at the H level, and the signal attains an L level. Therefore, after replacing the battery 300 mounted in the slot 201 with the AC adapter 203, at startup by the first power-on, it is determined in step S301 that the signal level of the communication line is the L level.

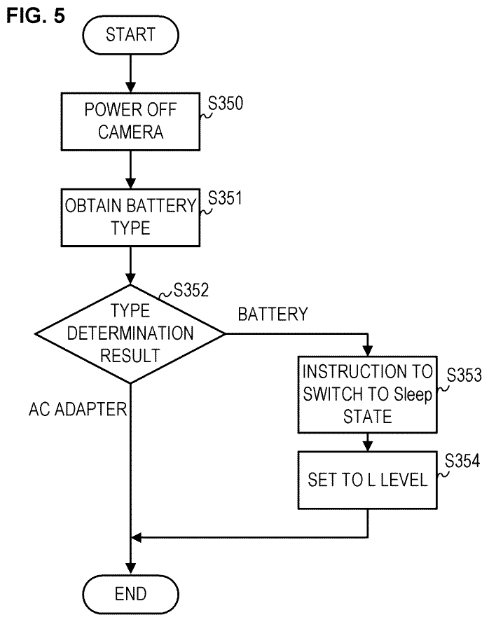

FIG. 5 is a flowchart of the processing excerpted from the program executed at the shutdown of the digital camera 100 by the system control unit 50. The shutdown processing in FIG. 5 includes the processing executed when the user powers off the digital camera 100 by operating the power switch 72. The shutdown processing in FIG. 5 also includes the processing executed when the digital camera 100 transitions to an auto power-off state. If no operation is performed on the digital camera 100 for a certain period, the system control unit 50 transitions the digital camera 100 to the auto power-off state. Furthermore, if any operation is performed on the digital camera 100 in the auto power-off state, the system control unit 50 executes the startup processing shown in FIG. 4.

In step S350, the system control unit 50 performs power-off processing for the digital camera 100. Specifically, the system control unit 50 controls the power source control unit 80 to stop the supply of power to each block of the digital camera 100. As a result, the system control unit 50 disables functions such as capturing or playing back images (still images or moving images).

In step S351, the system control unit 50 controls the power source control unit 80 to communicate with the power source unit 30 in the same way as in step S304 and obtains battery type information.

In step S352, the system control unit 50 determines whether the power source unit 30 (the power source unit 30 mounted in the slot 201) is the battery 300 or the AC adapter 203 on the basis of the battery type information. If it is determined that the power source unit 30 is the battery 300, the process proceeds to step S353. If it is determined that the power source unit 30 is the AC adapter 203, the processing of this flowchart ends. Therefore, if it is determined that the power source unit 30 is the AC adapter 203, the system control unit 50 controls the signal level of the communication line between the power source control unit 80 and the power source unit 30 to be maintained at the present level even after the digital camera 100 is powered off.

In step S353, the system control unit 50 controls the power source control unit 80 to instruct the power source unit 30 to transition to the sleep state. In this case, the power source unit 30 sets the controller in the battery 300 to transition to a low-power consumption mode, thereby reducing the power consumption of the battery 300.

In step S354, the system control unit 50 sets the communication line between the power source control unit 80 and the power source unit 30 to output an L level.

With reference to the flowchart of FIG. 6, the processing performed by the control unit 251 in the AC adapter 203 will be described. When the USB connector 204 of the AC adapter 203 is connected to the PD power adapter 205, power is supplied from the PD power adapter 205. When connected to the PD power adapter 205, the control unit 251 is activated by the power from the PD power adapter 205.

In step S400, the control unit 251 controls the PD controller 252 to start communication with the PD power adapter 205 and performs the power negotiation of USBPD. The control unit 251 then requests the PD power adapter 205 to supply power at a voltage of 15 V. The PD controller 252 requests the PD power adapter 205 to supply 15 V, and the PD power adapter 205 outputs a voltage of 15 V.

In step S401, the control unit 251 controls the output voltage detection unit 260 to read the output voltage from the AC adapter 203 to the digital camera 100. Here, as described above, the input voltage of 15 V from the PD power adapter 205 is converted to half by the switched capacitor 253, and the output voltage becomes 7.5 V.

In step S402, the control unit 251 determines whether the output voltage obtained in step S401 is 7.5 V. If it is determined that the output voltage is 7.5 V, the process proceeds to step S403. If it is determined that the output voltage is not 7.5 V, the processing of steps S401 and S402 is repeated.

In step S403, the control unit 251 sets the FET 256 to ON. This supplies power to the digital camera 100 if the digital camera 100 is connected to the terminal 250. Then, the system control unit 50 executes the processing shown in the flowchart of FIG. 4 so that the power source control unit 80 of the digital camera 100 can detect the power necessary to start up the digital camera 100 being supplied. As a result, the digital camera 100 is supplied with power at an initial voltage of 7.5 V.

In step S404, the control unit 251 monitors the output of the USB connection detection unit 259 to determine whether the USB connection has been disconnected (i.e., whether the disconnection between the USB connector 204 and the PD power adapter 205 has occurred). If it is determined that the USB connection has been disconnected, the process proceeds to step S420. If it is determined that the USB connection is still active, the process proceeds to step S405.

In step S405, the control unit 251 determines the signal level of the communication line 263. If it is determined that the signal level of the communication line 263 is the H level, it is determined that there is no communication between the digital camera 100 and the AC adapter 203, and the process returns to step S404. Meanwhile, if the signal level of the communication line 263 is the L level, it can be considered that the “communication is ongoing” or “the AC adapter 203 is disconnected from the slot 201.” Therefore, if it is determined that the signal level of the communication line 263 is the L level, the process proceeds to step S406 in order to determine which event has occurred.

In step S406, the control unit 251 measures the period of time (duration) during which the signal level of the communication line 263 remains at the L level using a non-attachment detection timer. If the timer is currently in the process of measuring the duration, the process proceeds to step S407. If the timer has finished measuring the duration, it is determined that the AC adapter 203 has been removed from the slot 201, and the process proceeds to step S418. According to the first embodiment, the timer measures the period of time during which the signal level of the communication line 263 remains at the L level for a predetermined period of time (e.g., 500 ms), and then terminates the measurement.

In step S407, the control unit 251 determines the signal level of the communication line 263. If it is determined that the signal level of the communication line 263 is the H level, which indicates that the signal has attained an H level during measurement by the timer, it is determined that communication is ongoing between the digital camera 100 and the AC adapter 203, and the process proceeds to step S408. If it is determined that the signal level of the communication line 263 remains at the L level, the process returns to step S406.

In step S408, the control unit 251 receives data (including commands) transmitted from the power source control unit 80 to the AC adapter 203.

In step S409, the control unit 251 stops the non-attachment detection timer and clears the count value of the duration (sets it to 0).

In step S410, the control unit 251 determines whether the command obtained in step S408 (hereinafter referred to as the “obtained command”) is a type determination command (a command that requests type determination for the power source unit 30). If it is determined that the obtained command is a type determination command, then the process proceeds to step S411. If it is determined that the obtained command is not a type determination command, then the process proceeds to step S413.

In step S411, the control unit 251 reads out the type information from the non-volatile memory 264. The type information includes information on whether the power source unit 30 is the battery 300 or the AC adapter 203, whether it is compatible with the USB PD standard, and information determined by the AC adapter 203.

In step S412, the control unit 251 transmits the type information obtained in step S411 to the power source control unit 80.

In step S413, the control unit 251 determines whether the obtained command is a 10 V command (a command that requests the output of a voltage of 10 V). If it is determined that the obtained command is a 10 V command, the process proceeds to step S414. If it is determined that the obtained command is not a 10 V command, the process proceeds to step S415.

In step S414, the control unit 251 requests the PD power adapter 205 to supply power at 20 V (performs negotiation with the PD power adapter 205). In this case, the control unit 251 controls the PD controller 252 to communicate with the PD power adapter 205.

In step S415, the control unit 251 determines whether the obtained command is a command that requests a response for the output voltage (hereinafter referred to as a “response command”). If it is determined that the obtained command is a response command, the process proceeds to step S416. If it is determined that the obtained command is not a response command, the process returns to step S404.

In step S416, the control unit 251 controls the output voltage detection unit 260 to detect the output voltage.

In step S417, the control unit 251 transmits the output voltage information (information on the output voltage value) obtained in step S416 to the power source control unit 80.

In step S418, the control unit 251 communicates with the PD controller 252 to determine the present negotiation voltage. Here, the negotiation voltage is the voltage that the PD controller 252 requests to be supplied from the PD power adapter 205. If it is determined that the negotiation voltage is 20 V, the process proceeds to step S419. If it is determined that the negotiation voltage is not 20 V, the process returns to step S404.

In step S419, the control unit 251 controls the PD controller 252 to start communication with the PD power adapter 205 and requests for the supply of power at 15 V (performs negotiation). If the processing in step S418 is not performed and the timer has finished measuring the duration in step S406, the process may proceed to step S419.

In step S420, the control unit 251 requests the digital camera 100 to execute the processing of the flowchart of FIG. 5 by transmitting a request to stop the camera function to the power source control unit 80. As the PD power adapter 205 is disconnected from the USB connector 204, power from the capacitor 255 is output to the digital camera 100 via the AC adapter 203. Therefore, before the output from the capacitor 255 decreases and the power supply from the AC adapter 203 stops, the system control unit 50 performs the power-off processing of the digital camera 100. The system control unit 50 controls the power source control unit 80 to stop supplying power to each block of the digital camera 100. Thereafter, when the power supply from the AC adapter 203 is stopped, the level of the communication line with the power source unit 30 can no longer be maintained at the H level, dropping to the L level and entering a power-off state.

According to the first embodiment, at the power-on, if the signal level of the communication line with the AC adapter 203 is the L level, the digital camera 100, in principle, requests the AC adapter 203 to supply the power at the voltage requested by the digital camera 100 (requested voltage) and determines the supply voltage from the AC adapter 203. Meanwhile, at the power-on, if the signal level of the communication line with the AC adapter 203 is the H level, the digital camera 100 does not request the supply of the requested voltage. Therefore, the digital camera 100 receives the supply of the power at the most recently requested voltage by the digital camera 100 (before power off) from the AC adapter 203. The digital camera 100 controls the signal level of the communication line with the AC adapter 203 at power-off to be maintained after the power off. Therefore, when the power is turned off while the digital camera 100 is supplied with 10 V, which is the voltage requested by the digital camera 100, from the AC adapter 203, the signal level of the communication line with the AC adapter 203 is maintained at the H level. In this state, if the digital camera 100 is powered on again, the signal level of the communication line with the AC adapter 203 is maintained at the H level, so that the AC adapter 203 does not perform power negotiation.

Therefore, the startup time of the digital camera 100 can be shortened. Power negotiation is performed when it is necessary, and therefore the AC adapter 203 can provide the digital camera 100 with appropriate power.

According to the present invention, it is possible to prevent an increase in startup time of an electronic device capable of requesting voltage for power to be received from an accessory.

As in the foregoing, the present invention has been described in detail with reference to the preferred embodiments, but the present invention is not limited by these specific embodiments, and various forms that do not deviate from the gist of the invention are also encompassed by the present invention. Some of the above embodiments may be combined as appropriate.

In the above description, “if A is equal to or greater than B, the process proceeds to step S1, and if A is less (lower) than B, the process proceeds to step S2” may be interpreted as “if A is greater (higher) than B, the process proceeds to step S1, and if A is equal to or less than B, the process proceeds to step S2.” Conversely, “if A is greater (higher) than B, the process proceed to step S1, and if A is equal to or less than B, the process proceeds to step S2” can also be interpreted as “if A is equal to or greater than B, the process proceeds to step S1, and if A is less (lower) than B, the process proceeds to step S2.” Therefore, as long as there is no contradiction, “A or more” can be interpreted as “greater than A (higher, longer, or more)” and “A or less” can be interpreted as “less than A (lower, shorter, or fewer).” Also, “greater than A (higher, longer, or more)” can be interpreted as “A or more,” and “less than A (lower, shorter, or fewer)” can be interpreted as “A or less.”

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-031896, filed on Mar. 4, 2024, which is hereby incorporated by reference herein in its entirety.

What is claimed is:

1. An electronic device to which a predetermined power-supplying accessory is detachably connected, the electronic device comprising:
a processor; and
a memory storing a program which, when executed by the processor, causes the electronic device to function as:
a communication unit configured to perform communication with the predetermined accessory via a communication line, wherein the communication unit executes such communication processing that at startup of the electronic device, 1) the predetermined accessory is requested to supply power at a first voltage in case where the communication line has a signal level at a first level, and 2) the predetermined accessory is not requested to supply the power at the first voltage in case where the signal level of the communication line is a second level;
a setting unit configured to perform setting processing to set the signal level of the communication line to the second level in case where the predetermined accessory is requested by the communication unit to supply the power at the first voltage; and
a control unit configured to perform such control that after power off of the electronic device, the signal level of the communication line at the power-off of the electronic device is maintained.

2. The electronic device according to claim 1, wherein the program, when executed by the processor, further causes the electronic device to function as:
a power source control unit configured to receive voltage output from the predetermined accessory,
wherein the power source control unit 1) receives the first voltage from the predetermined accessory in case where the predetermined accessory is requested to supply the first voltage, and 2) receives second voltage lower than the first voltage in case where the predetermined accessory is not requested to supply the first voltage.

3. The electronic device according to claim 2, wherein the second voltage is predetermined voltage supplied from the predetermined accessory in case where the predetermined accessory is not requested to supply the first voltage by the communication unit.

4. The electronic device according to claim 2, wherein in case where the predetermined accessory is requested to supply the first voltage by the communication unit, the predetermined accessory performs processing for changing output voltage output from the predetermined accessory from the second voltage to the first voltage.

5. The electronic device according to claim 4, wherein in case where a power supply device is connected to the predetermined accessory, the predetermined accessory receives power from the power supply device according to USB Power Delivery (USB PD) standard, generates output voltage to the electronic device from the input voltage supplied by the power supply device, and outputs the generated output voltage to the electronic device, and
the processing for changing is USB PD power negotiation processing.

6. The electronic device according to claim 1, further comprising a slot in which the predetermined accessory and a battery can be mounted, wherein
the control unit performs such control that 1) in case where the predetermined accessory is mounted in the slot, after power-off of the electronic device, the signal level of the communication line at the power-off of the electronic device is maintained, and 2) in case where the battery is mounted in the slot and the electronic device is powered off, the signal level of the communication line is set to the first level.

7. The electronic device according to claim 1, wherein
the first level is an L level, and
the second level is an H level.

8. The electronic device according to claim 7, wherein in case where the communication unit receives a request to stop power supply from the predetermined accessory, the control unit controls the setting unit to power off the electronic device before the power supply from the predetermined accessory is stopped, and
wherein the signal level of the communication line becomes the first level.

9. A system having an electronic device and a predetermined power-supplying accessory detachably connected to the electronic device, wherein
the electronic device performs processing to communicate with the predetermined accessory via a communication line, wherein the electronic device performs first communication processing including, at startup of the electronic device, 1) requesting the predetermined accessory to supply power at a first voltage in case where the communication line has a signal level at a first level, and 2) refraining from requesting the predetermined accessory to supply the power at the first voltage in case where the signal level of the communication line is a second level,
the electronic device performs setting processing including setting the signal level of the communication line to the second level in case where the predetermined accessory is requested to supply the power at the first voltage by the first communication processing,
after power-off of the electronic device, the electronic device executes first control processing including controlling the signal level of the communication line at the power-off of the electronic device to be maintained,
the predetermined accessory performs supply processing including receiving input voltage from a power supply device connected to the predetermined accessory, generating output voltage from the input voltage, and supplying the generated output voltage to the electronic device,
the predetermined accessory executes second control processing including controlling the supply processing so that in case where the request by the first communication processing is not performed, an output voltage at a second voltage lower than the first voltage is supplied, and in case where the request by the first communication processing is performed, an output voltage at the first voltage is supplied, and
in the second control processing, in case where the signal level of the communication line is maintained at the second level, the processing for changing the output voltage by the supply processing is not performed.

10. The system according to claim 9, wherein
in the supply processing, 1) in case where the request by the first communication processing is not performed, the predetermined accessory device requests the power supply device to supply a third voltage corresponding to the second voltage, and generates the second voltage from the third voltage as the output voltage to the electronic device, and 2) in case where the processing for changing the output voltage to the first voltage is executed, the predetermined accessory requests the power supply device to supply a fourth voltage corresponding to the first voltage, and generates the first voltage from the fourth voltage as the output voltage to the electronic device.

11. The system according to claim 9, wherein the predetermined accessory receives power from the power supply device according to USB Power Delivery standard.

12. A method for controlling an electronic device to which a predetermined power-supplying accessory is detachably connected, the method comprising:
communicating with the predetermined accessory via a communication line, the communicating including, at startup of the electronic device, 1) requesting the predetermined accessory to supply power at a first voltage in case where the communication line has a signal level at a first level, and 2) refraining from requesting the predetermined accessory to supply the power at the first voltage in case where the signal level of the communication line is a second level;
setting the signal level of the communication line to the second level in case where the predetermined accessory is requested to supply the power at the first voltage in the communicating; and
controlling, after power-off of the electronic device, the signal level of the communication line at the power-off of the electronic device to be maintained.

13. A non-transitory computer-readable medium that stores a program, wherein the program causes a computer to execute a method for controlling an electronic device to which a predetermined power-supplying accessory is detachably connected,
the method comprising:
communicating with the predetermined accessory via a communication line, the communicating including, at startup of the electronic device, 1) requesting the predetermined accessory to supply power at a first voltage in case where the communication line has a signal level at a first level, and 2) refraining from requesting the predetermined accessory to supply the power at the first voltage in case where the signal level of the communication line is a second level;
setting the signal level of the communication line to the second level in case where the predetermined accessory is requested to supply the power at the first voltage in the communicating; and
controlling, after power-off of the electronic device, the signal level of the communication line at the power-off of the electronic device to be maintained.
